(19) United States
(12) Patent Application Publication
(10) Pub. No.: US 2016/0343461 A1
(43) Pub. Date: Nov. 24, 2016

(54) RADIATION BARRIER FOR WEARABLE PERSONAL ELECTRONIC DEVICE, SYSTEM INCLUDING WEARABLE PERSONAL ELECTRONIC DEVICE AND RADIATION BARRIER, AND WEARABLE PERSONAL ELECTRONIC DEVICE INCLUDING RADIATION BARRIER

(71) Applicant: Claire Ann Boyer, Saratoga, CA (US)

(72) Inventor: Claire Ann Boyer, Saratoga, CA (US)

(21) Appl. No.: 14/961,354

(22) Filed: Dec. 7, 2015

Related U.S. Application Data
(60) Provisional application No. 62/101,137, filed on Jan. 8, 2015.
(60) Provisional application No. 62/101,144, filed on Jan. 8, 2015.

(51) Int. Cl. G21F 1/12; G21F 3/00

(52) U.S. Cl. CPC G21F 1/125; G21F 3/00

(57) ABSTRACT

The disclosure provides a radiation barrier and system including at least one radiation barrier and a radiation emitting device. The radiation barrier may be used with radiation emitting devices to minimize a wearer's exposure to radiation produced therefrom.

### CROSS-REFERENCE TO RELATED APPLICATIONS

This application is related and claims priority to U.S. Provisional Application No. 62/101,137 filed Jan. 8, 2015, and U.S. Provisional Application No. 62/101,144 filed Jan. 8, 2015, the entire contents of which are hereby incorporated by reference in their entireties.

### FIELD OF THE INVENTION

This disclosure relates generally to a radiation barrier for limiting transmission of radiation from a wearable electronic device and a system including a wearable personal electronic device and one or more radiation barriers.

### BACKGROUND

Need exists for improved wearable personal electronic devices. Need also exists for improved systems including wearable personal electronic devices.

### BRIEF SUMMARY OF THE INVENTION

The subject matter disclosed herein provides for improved wearable electronic devices which emit radiation. Such devices, which are often located proximate to a person or animal's body (e.g., smart watches, health and/or fitness trackers, phone headsets, etc.), expose the wearer to radiation. Radiation exposure is cumulative, and unlike PDA's, tablets, etc., wearable radiation emitting devices are most often worn both immediately next to the skin and on the same place of the wearer for long periods of time. Such long term, localized exposure to radiation may cause harm to the body.

The disclosed subject matter provides for a radiation barrier. Such a radiation barrier may include a plurality of discrete layers combined together to assist in preventing the transmission of radiation from the wearable device to the wearer's body. Included in these plurality of layers may be one or more radiation reflecting, radiation absorbing, and adhesive layers, as well as a liner designed to prevent the adhesive layer from being corrupted or adhering to objects before it is applied to a radiation emitting device. The adhesive layer may be configured to be removably affixable to one or more of the liner and the radiation emitting device.

The radiation barrier may, optionally, have a laminated layer attached to the radiation absorbing/reflecting layer on the side opposite the adhesive layer. The laminated layer may have a liner layer removably affixed to it on the side opposite the radiation absorbing/reflecting layer, the liner layer provided to protect the laminated layer.

Also provided for in this disclosure is an apparatus consisting of one or more radiation barriers as described hereinabove incorporated into or onto an electronic device that emits radiation. Such an apparatus may have a radiation barrier internally integrated into the device, adhered to the exterior of the device, or both.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features, and advantages here provided will become apparent to one with skill in the art upon examination of the following FIGURES and detailed description. It is intended that all such additional systems, methods, features, and advantages that are included within this description, be within the scope of the appended claims and/or those claims filed later.

### BRIEF DESCRIPTIONS OF THE DRAWINGS

The novel features believed characteristic of the presently disclosed subject matter are set forth in the claims appended hereto, or will be set forth in any claims that are filed herewith or later. The presently disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 displays a side perspective view of a radiation barrier apparatus in accordance with embodiments.

FIG. 2 displays a side perspective view of the radiation barrier apparatus affixed to a portion of a radiation emitting device.

FIG. 3 displays how an embodiment of a radiation barrier apparatus may be associated with a radiation emitting device.

FIG. 4 displays a perspective view of the components of the radiation barrier system affixed to one another in accordance with embodiments.

FIG. 5 displays a perspective view of a radiation barrier system in accordance with embodiments.

FIG. 6 displays an open side view of a radiation barrier system in accordance with embodiments.

FIG. 7 displays a perspective view of a radiation barrier system in accordance with embodiments.

FIG. 8 displays a perspective view of a radiation barrier system including a radiation barrier attachment affixed to a bottom portion of a radiation emitting device in accordance with embodiments.

FIG. 9 displays a side view of a radiation barrier system including a radiation barrier attachment affixed to a bottom portion of a radiation emitting device in accordance with embodiments.

FIG. 10 displays a front view of a radiation barrier attachment in accordance with embodiments.

FIG. 11 displays a side perspective view of a radiation barrier apparatus in accordance with embodiments.

### DETAILED DESCRIPTION OF THE SPECIFIC EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

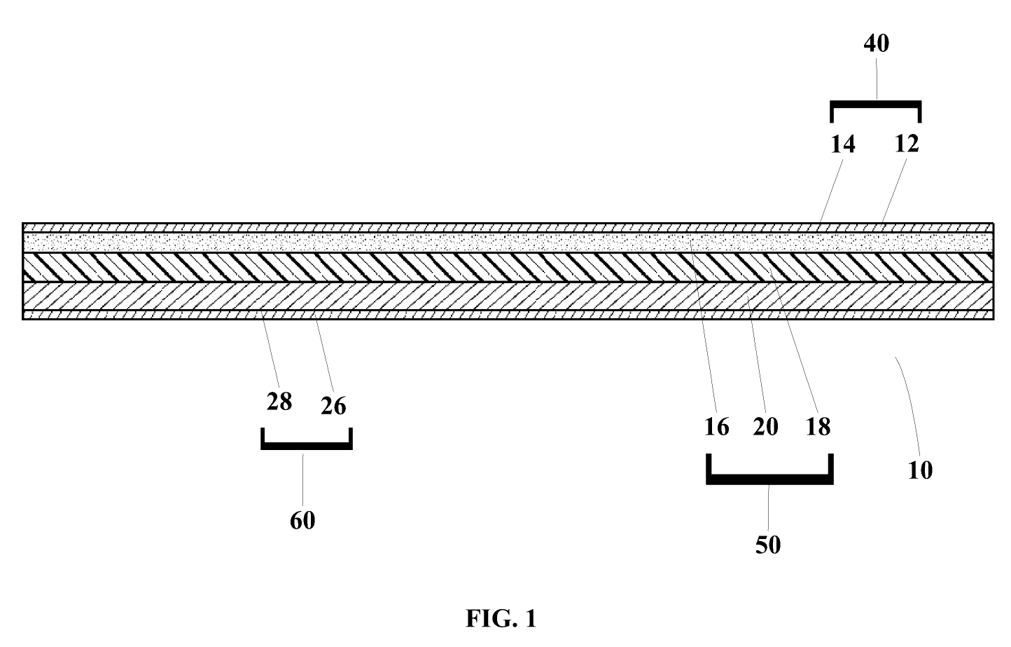

FIG. 1 displays a side perspective view of a radiation barrier apparatus 10 in accordance with embodiments. The apparatus 10 may comprise a first layer 40 comprising a first liner portion 12 and a first silicone portion 14 affixed to the first liner portion 12.

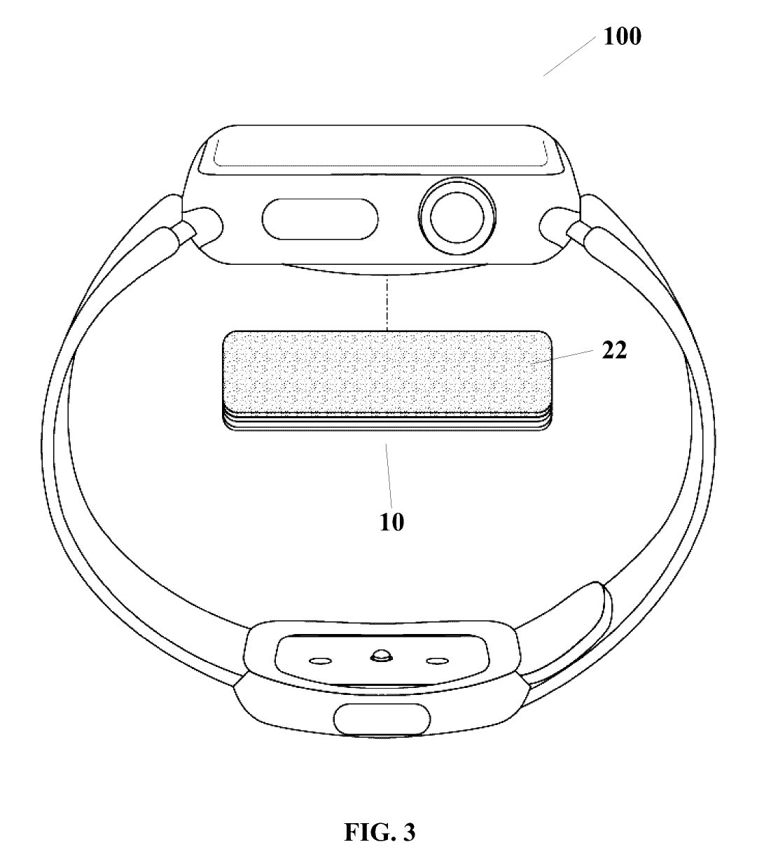

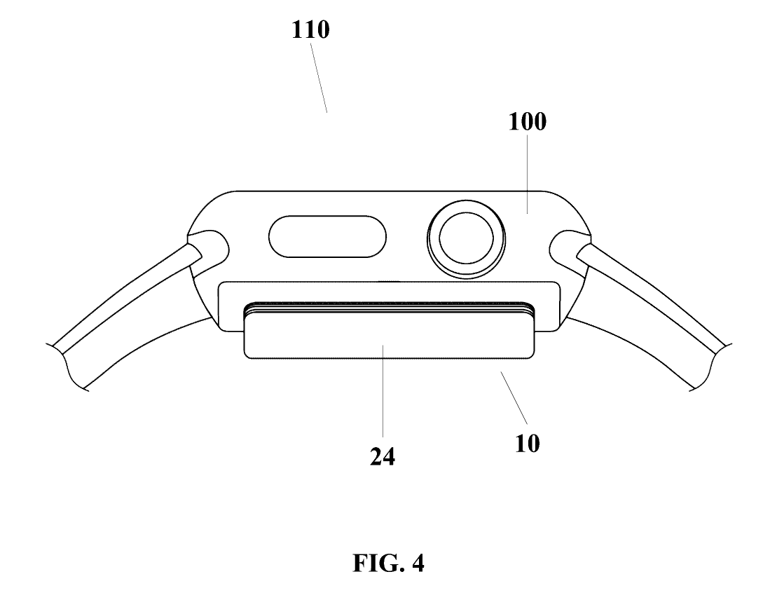

The apparatus may further comprise an adhesive layer 50 comprising an adhesive portion 16, a radiation reflecting portion 18, a lamination portion 20, an adhesive surface 22 (see FIG. 3), and a lamination surface 24 (see FIG. 4). In embodiments, the adhesive surface 22 may be removably affixable to the first silicone portion 14 of the first layer 40. The adhesive portion 16 may comprise the adhesive surface 22 and may be viewable when the first layer 40 is removed from apparatus 10. The lamination portion 20 may comprise the lamination surface 24 and may be viewable when the second layer 60 is removed from apparatus 10.

The apparatus may further comprise a second layer 60 comprising a second liner portion 26 and a second silicone portion 28. The second silicone portion 28 may be removably affixable to the lamination surface 24. The second layer 60 may provide protection to the lamination portion 20 prior to the apparatus 10 being utilized in conjunction with a radiation emitting device 100 (such as, but not limited to, providing protection during shipping of apparatus 10). In embodiments, a second layer 60 may be absent from apparatus 10.

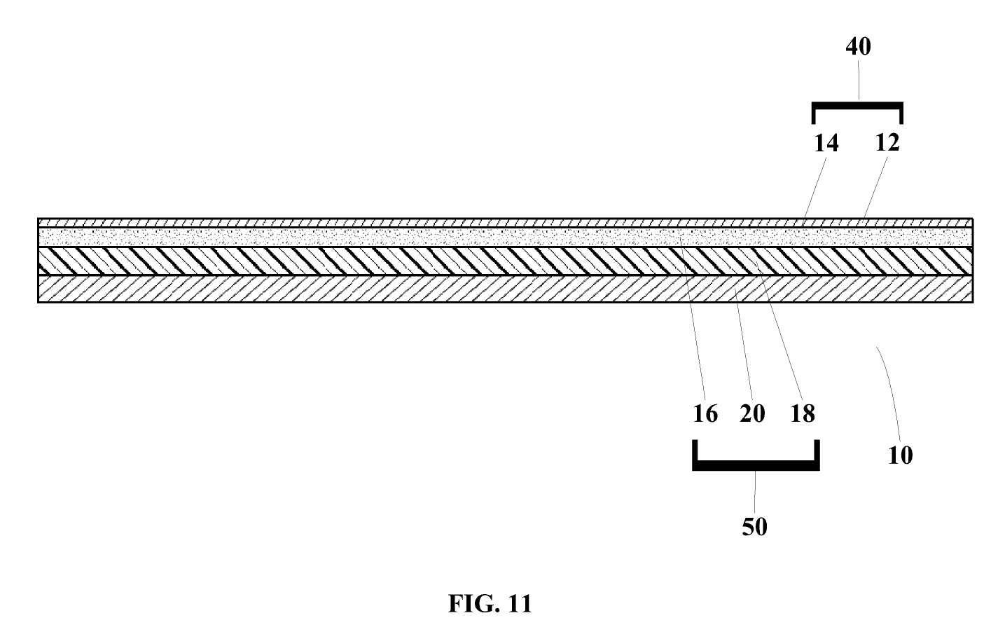

FIG. 11 displays a side perspective view of a radiation barrier apparatus 10 in accordance with embodiments. The radiation barrier apparatus 10 shown in FIG. 11 may essentially be identical to apparatus 10 found in FIG. 1 as shown and described less the second layer 60. In embodiments, a radiation barrier apparatus 10 may comprise one of the first layer 40 and the second layer 60.

In embodiments, liner portion 12 may be removed in order to apply the adhesive portion 16 to a surface, such as the surface of a radiation emitting wearable device between the source of radiation and the wearer's body.

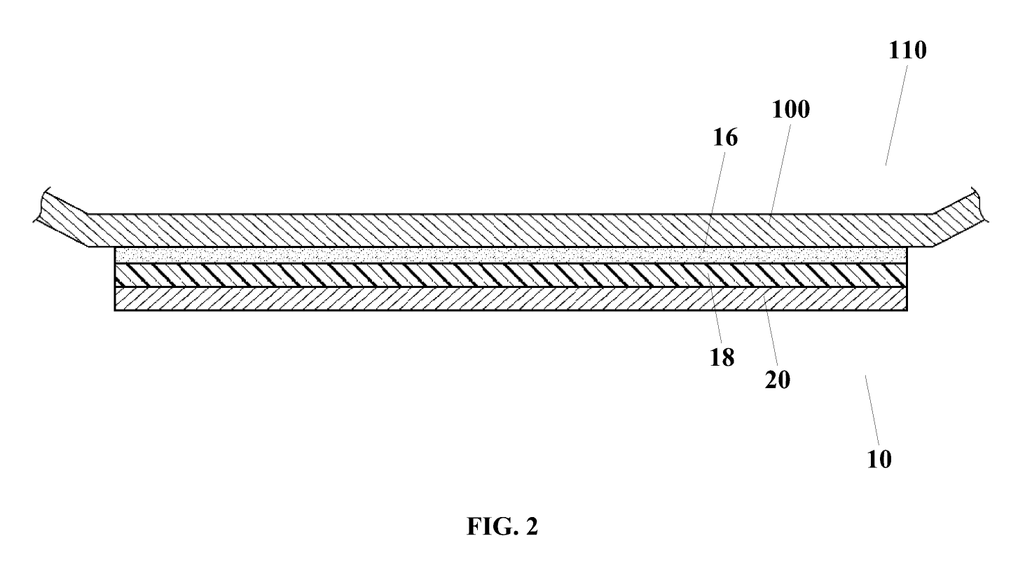

FIG. 2 displays a side perspective view of the radiation barrier apparatus 10 affixed to an external portion of a radiation emitting device 100. For the purposes of this disclosure, the apparatus 10 and radiation emitting device 100 may be referred to as a radiation barrier system 110. The adhesive portion 16 may be located adjacent to a portion of a radiation emitting device 100. The radiation reflecting portion 18 may be positioned adjacent to the adhesive layer 50. The lamination portion 20 may be positioned adjacent to the radiation reflecting portion 18. In embodiments, the lamination portion 20 may provide protection as well as increased aesthetics (e.g. may be colored or have some design) for the radiation reflecting portion 18. It is noted that the radiation barrier apparatus 10 is affixed to the bottom portion of a radiation emitting device 100 that may typically be adjacent an individual's wrist or other body part if the radiation barrier apparatus 10 were absent. In embodiments, the lamination portion 20 may be positioned adjacent an individual's wrist or other body part when the radiation emitting device 100 in combination with the radiation barrier apparatus 10 is worn by the individual.

FIG. 3 displays how an embodiment of a radiation barrier apparatus 10 may be associated with a radiation emitting device 100 in order to form a radiation barrier system 110. FIG. 4 displays a perspective view of the components of the radiation barrier system 110 affixed to one another in accordance with embodiments. Specifically, FIG. 4 shows an embodiment wherein radiation barrier apparatus 10 is adhered via adhesive surface 22 to an external surface of radiation emitting device 100. System 110 may comprise an adhesive layer 50 comprising an adhesive portion 16, a radiation reflecting portion 18, a lamination portion 20, an adhesive surface 22, and a lamination surface 24.

System 110 may further comprise a radiation emitting device 100 adhered to the adhesive surface 22 of the adhesive layer 50.

In embodiments, the system 110 may further comprise a protective layer comprising a liner portion 12,26 and a silicone portion 14,28. In embodiments, the silicone portion 14,28 may be removably affixable to the lamination surface 24. In embodiments, the protective layer may be one of the first layer 40 and the second layer 60.

In embodiments, the thickness of the adhesive layer 50 may be less than 0.1 millimeters. In embodiments, the thickness of the adhesive layer 50 may be 0.07 millimeters. In embodiments, the radiation reflecting portion 18 may comprise copper. A sufficient thickness of copper may provide sufficient radiation reflection when an individual is wearing a radiation emitting device 100. In embodiments, the radiation reflecting portion 18 may comprise at least one of copper, lead, silver, tungsten, and gold. In embodiments, the radiation reflecting portion 18 may comprise at least one metal and/or alloy that may provide a shielding and/or reflecting effect on radiation emitted from a radiation emitting device 100.

In embodiments, the adhesive layer 50 may further comprise an ink portion. In embodiments, the ink portion may be adhered to at least a portion of the radiation reflecting portion 18. In embodiments, the ink portion may be adhered to at least a portion of the lamination surface 24. In embodiments, the ink portion may comprise, for example, HKP BW8 Dense Black #9 distributed by the Flint Group.

In embodiments, the ink portion may one or more colors of ink.

In embodiments, the liner portion 12,26 may be, for example, Alliance Improved Release (2.5 mm) distributed by Twin Rivers Paper Company.

In embodiments, the lamination portion 20 may be 0.95 mm clear polypropylene overlaminate distributed by Sekisui Ta Industries, LLC.

In embodiments, the adhesive portion 16 may be Novamelt® (a registered trademark of Novamelt Americas, LLC), a hot melt pressure sensitive adhesive distributed by Novamelt Americas, LLC.

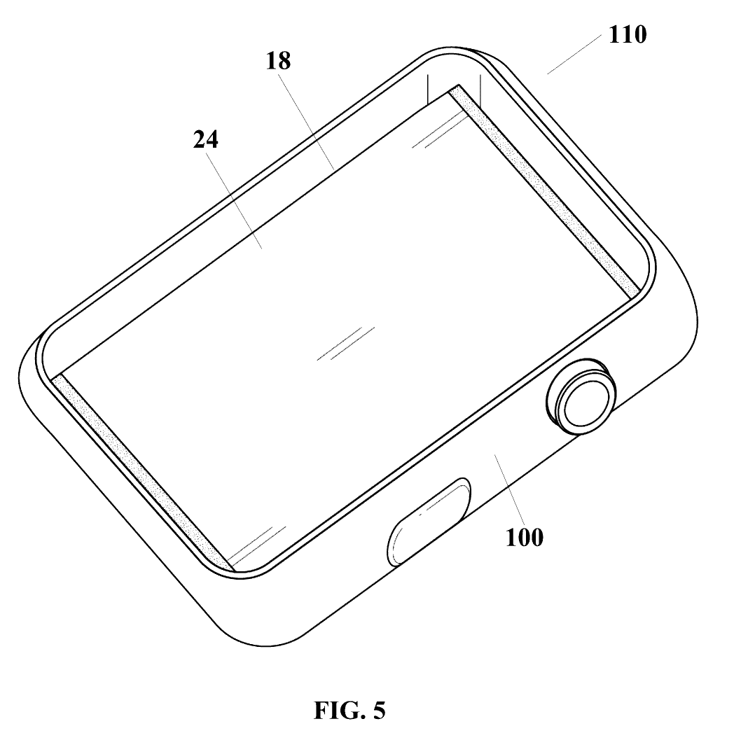

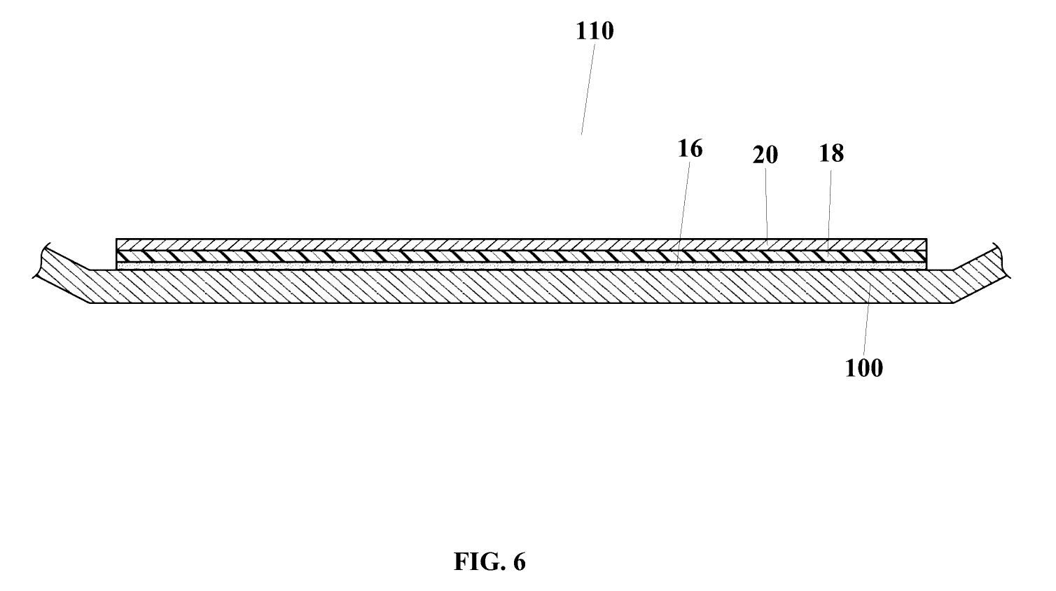

FIG. 5 displays a perspective view of a radiation barrier system 110 in accordance with embodiments, wherein radiation barrier apparatus 10 is adhered to the internal surface of a radiation emitting device 100. The lamination surface 24 may be shown facing a direction outward from the interior of radiation emitting device 100. FIG. 6 displays an open side view of a radiation barrier system 110 in accordance with embodiments. The system may comprise a radiation emitting device 100 comprising an interior bottom surface and an internal component portion comprising a top surface and a bottom surface. The system 100 may further comprise a barrier layer comprising a radiation reflecting portion 18. In embodiments, the barrier layer may be adjacent the interior bottom surface of the radiation emitting device 100 and the bottom surface of the internal components of the radiation emitting device 100. The radiation reflecting portion 18 positioned within a radiation emitting device 110 may keep a wearer of the device 110 from having to purchase apparatus 10, thus saving the wearer time and money.

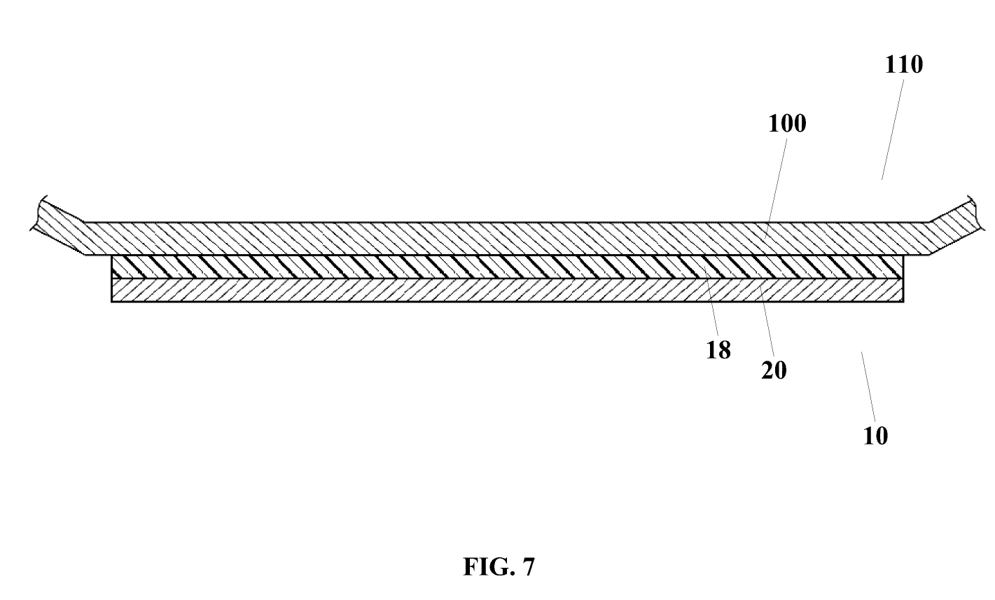

FIG. 7 displays a perspective view of a radiation barrier system 110 in accordance with embodiments. It is noted that the in the embodiment depicted in FIG. 7 adhesive layer 50 does not include the adhesive portion 16. In embodiments, the radiation reflecting portion 18 may be plated directly onto a portion of a radiation emitting device 100, eliminating the need for an adhesive portion 16. In embodiments, the lamination portion 20 may be deposited on top of a surface of the plated radiation reflecting portion 18. In embodiments, the plated radiation reflecting portion 18 may be deposited on a radiation emitting device 100 via plasma laser deposition. It is noted that the radiation barrier apparatus 10 is affixed to the bottom portion of a radiation emitting device 100 that may typically be adjacent an individual's wrist or other body part if the radiation barrier apparatus 10 were absent. In embodiments, the lamination portion 20 may be positioned adjacent an individual's wrist or other body part when the radiation emitting device 100 in combination with the radiation barrier apparatus 10 is worn by the individual.

In embodiments, the radiation barrier system 110 may further comprise at least one adhesive portion 16 affixed to the radiation reflecting portion 18. In embodiments, the at least one adhesive portion 16 may be removably affixable to at least one of the interior bottom surface of the radiation emitting device 100 and the bottom surface of the internal components of the radiation emitting device 100.

In embodiments, the radiation barrier system 110 may further comprise a lamination portion 20 including a lamination surface 24. In embodiments, the lamination portion 20 may comprise at least one polymer.

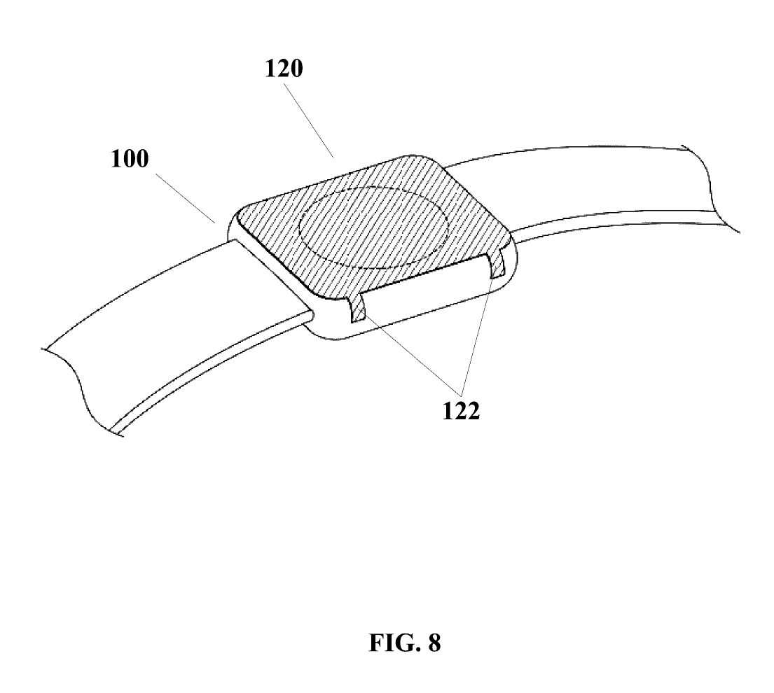

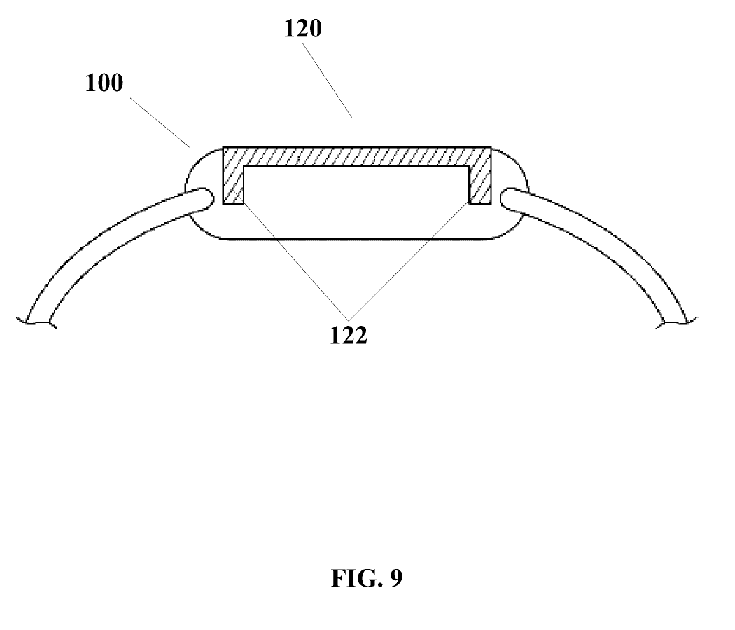

FIG. 8 displays a perspective view of a radiation barrier system 110 including a radiation barrier attachment 120 affixed to a bottom portion of a radiation emitting device 100 in accordance with embodiments. The radiation barrier attachment 120 may affix to the bottom portion of a radiation emitting device 100, such as in this case a wearable device. The radiation barrier attachment 120 may comprise a top surface and a bottom surface. The bottom surface of the radiation barrier attachment 120 may comprise a surface that may be integrated to seamlessly be positioned adjacent a bottom portion of the radiation emitting device 100. In embodiments, the radiation barrier attachment 120 may comprise a plurality of extensions 122 that may be positioned against the radiation emitting device 100 in order to provide an attachment means for the radiation barrier attachment 120. In embodiments, edges of the extensions 122 may be positioned in a groove to restrict movement of the radiation barrier attachment 120. In embodiments, when the radiation barrier attachment 120 is placed on a radiation emitting device 100 with rounded edges (such as the radiation emitting device 100 shown in FIG. 8), the extensions 122 may extend more than halfway around the rounded edges in order to provide a form fit between the radiation barrier attachment 120 and the radiation emitting device 100. The side view shown in FIG. 9 may show the extensions 122 extending more than halfway around the rounded edges of the radiation emitting device 100. In embodiments, the extensions 122 may extend along axes perpendicular to a plane that the top surface of radiation emitting device 100 is positioned along.

It is noted in FIGS. 8 and 9 that the radiation emitting device 100 shown is upside down and the radiation barrier attachment 120 is affixed to the bottom portion of a radiation emitting device 100. In embodiments, the radiation barrier attachment 120 may be positioned adjacent an individual's wrist or other body part when the radiation emitting device 100 in combination with the radiation barrier attachment 120 is worn by the individual.

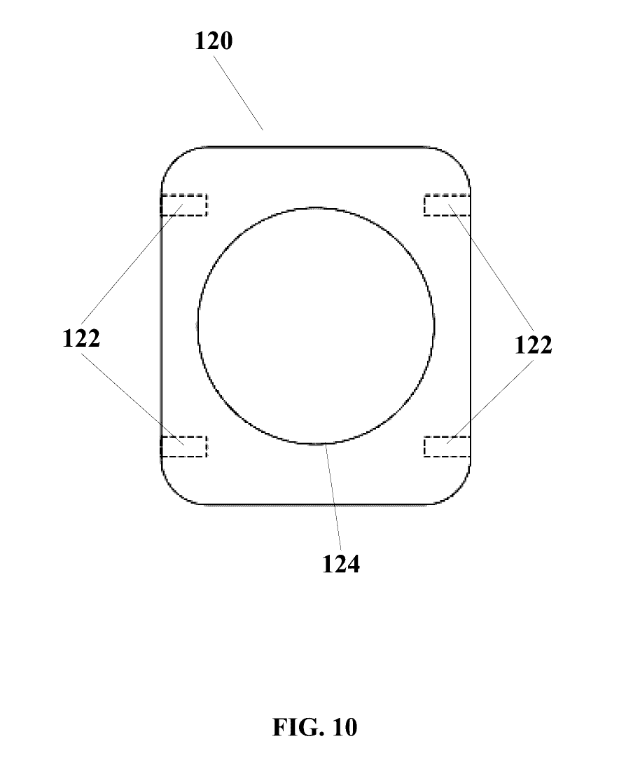

FIG. 10 displays a front view of a radiation barrier attachment 120 in accordance with embodiments. The bottom surface of the radiation emitting device 100 may comprise a plurality of extensions 122 (dotted lines) that may extend outward from the bottom surface. The bodies of the extensions 122 may curve inward toward one another. The curving may allow for the radiation barrier attachment 120 to properly adhere to a radiation emitting device 100. In embodiments, the radiation barrier attachment 120 may comprise an indentation 124. The indentation 124 may provide a space reserved for a protruding surface on the back face of a radiation emitting device 100. In embodiments, the indentation 124 may indent the opposite direction of the extension direction of the extensions 122.

In embodiments, first layer 40 and second layer 60 may be peeled off of apparatus 10 by an individual to reveal adhesive surface 22 and lamination surface 24.

In embodiments, the thickness of the barrier layer may be less than 0.1 mm. In embodiments, the thickness of the barrier layer may be 0.07 mm.

In embodiments, the radiation reflecting portion 18 may comprise copper.

In embodiments of the apparatuses or systems disclosed, the adhesive portion 16 may be removable from an external surface and not removable from the radiation reflecting portion 18. In embodiments of the apparatuses or systems disclosed, the adhesive portion 16 may not be removable from an external surface and also not removable from the radiation reflecting portion 18. In such cases, the adhesive portion 16 may comprise a permanent adhesive. An exemplary permanent adhesive may be epoxy.

In embodiments of the apparatuses or systems disclosed, the adhesive portion 16 may be removable from both an external surface and removable from the radiation reflecting portion 18. In these cases, the adhesive portion 16 may comprise a removable adhesive. An exemplary removable adhesive may be cured dimethacrylate ester.

In embodiments, the systems or apparatuses disclosed may further comprise a silicone layer that may provide comfort to an individual wearing the system. In embodiments, the silicone layer may further comprise a textile layer affixed to at least a portion of the silicone layer. The textile system may provide friction and/or sweat absorption when an individual is wearing the system. In embodiments, the silicone layer may be similar to silicone portion 14,28. In embodiments, the silicone layer may be thicker than silicone portion 14,28.

In embodiments, the silicone portions 14,28 of any of the disclosed apparatuses and systems may be sprayed onto any of the liner portions 12,26 of any of the disclosed apparatuses and systems. In embodiments, a silicone aerosol may be applied to any of the liner portions 12,26 of any of the disclosed apparatuses and systems. In embodiments, the aerosol may be applied via spraying the aerosol. In embodiments, the silicone portions 14,28 and the lamination surfaces 24 and adhesive surfaces 22 in any disclosed embodiments may affix to one another through electrostatic interactions. In embodiments, silicone portions 14,28 may allow liner portions 12,26 to be temporarily affixed to the adhesive portion 16. The liner portions 14,28 may be able to be peeled away from an adhesive portion 16 without any part of the adhesive portion 16 sticking to the liner portions 12,26.

In embodiments, an adhesive material utilized in an adhesive layer 50 of an apparatus or system may be structurally sound when exposed to heat from an individual's body, from the radiation emitting device 100, and from the external environment over a period of time.

In embodiments, the adhesive material affixed to the adhesive layers 50 on the apparatus or system may be structurally sound when exposed to a moist environment over a period of time.

In embodiments, the adhesive layer 50 or apparatus 10 may be configured to be affixed to any portion of a radiation emitting device 100, including radiation emitting devices not worn on the wrist.

For the purposes of this disclosure, one or more figures have not been drawn to scale in order to show the detail of layers of an apparatus or system. The actual apparatuses or systems may vary in size relative to the figures.

Radiation emitting devices 100 may use Bluetooth® to send and receive information from other electronic devices. Research has shown that the carrier waves given off from these devices have been found to be harmful or discomforting to individuals wearing the devices. The radiation reflecting portion 18 of the apparatuses and systems may provide a barrier that comprises a high reflection coefficient. Because the barrier has a high reflection coefficient, the carrier waves may reflect off and away from an individual when an individual is utilizing an apparatus or system of the disclosure.

In embodiments, the radiation reflecting portion 18 may alternatively comprise a material that may absorb radiation from a radiation emitting device. In embodiments, the radiation reflecting portion 18 may comprise one or more of a material that may absorb radiation from a radiation emitting device 100 and a material that may reflect radiation from a radiation emitting device 100.

In embodiments, the radiation reflecting portion 18 may be affixed to any portion of the aforementioned apparatuses and/or systems via means other than an adhesive portion 16 such as, but not limited to male-female engagement, static attraction, magnetic attraction, and plating.

In embodiments, the radiation reflecting portion 18 may be incorporated within the materials making up a radiation emitting device 100.

In embodiments, the radiation reflecting portion 18 may be granular. In embodiments, the radiation reflecting portion 18 may be a single continuous layer.

In embodiments, the radiation reflecting portion 18 may comprise a non-planar configuration such as, but not limited to, corrugated, curved, and folded. In embodiments, the radiation reflecting portion 18 may comprise a planar configuration.

In embodiments, the radiation reflecting portion 18 may be incorporated within an accessory of a radiation emitting device 100. In the case of a wearable smart device, the radiation reflecting portion 18 may be incorporated into accessories such as, but not limited to bands and jewelry.

In embodiments, the radiation reflecting material 18 may be ground into a powder and incorporated into a polymer that may be utilized in either a coating or an adhesive affixed to a radiation emitting device 110.

The foregoing description embodiments is provided to enable a person skilled in the art to make or use the claimed subject matter. Various modifications to these embodiments, including changing point values and/or adding or deleting point opportunities, will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

The detailed description set forth herein in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

Further, although exemplary devices and figures to implement the elements of the disclosed subject matter have been provided, one skilled in the art, using this disclosure, could develop additional hardware and/or software to practice the disclosed subject matter and each is intended to be included herein.

In addition to the above described embodiments, those skilled in the art will appreciate that this disclosure has application in a variety of arts and situations and this disclosure is intended to include the same.

1. An apparatus comprising:
a first layer comprising a first liner portion and a first silicone portion;
an adhesive layer comprising an adhesive portion, a radiation reflecting portion, a lamination portion, an adhesive surface, and a lamination surface, the adhesive surface removably affixable to the first silicone portion; and
a second layer comprising a second liner portion and a second silicone portion, the second silicone portion removably affixable to the adhesive surface.

2. The apparatus of claim 1, the thickness of the adhesive layer being less than 0.1 millimeters.

3. The apparatus of claim 2, the thickness of the adhesive layer being 0.07 millimeters.

4. The apparatus of claim 1, the radiation reflecting portion comprising at least one of copper, lead, silver, tungsten, and gold.

5. The apparatus of claim 1, the adhesive layer further comprising an ink portion, the ink portion adhered to at least one of at least a portion of the radiation reflecting portion and at least a portion of the lamination portion.

6. The apparatus of claim 5, the ink portion comprising at least one color.

7. The apparatus of claim 1, at least one of the first and second silicone portions being a sprayed-on portion.

8. A system comprising:
an adhesive layer comprising an adhesive portion, a radiation reflecting portion, a lamination portion, an adhesive surface, and a lamination surface; and
a radiation emitting device adhered to the adhesive surface of the adhesive layer.

9. The system of claim 8, further comprising a protective layer comprising a liner portion and a silicone portion, the silicone portion removably affixable to the lamination surface.

10. The system of claim 9, the silicone portion being a sprayed on portion.

11. The system of claim 8, the thickness of the adhesive layer being less than 0.1 millimeters.

12. The system of claim 10, the thickness of the adhesive layer being 0.07 millimeters.

13. The system of claim 8, the radiation reflecting portion comprising at least one of copper, lead, silver, tungsten, and gold.

14. The system of claim 8, the adhesive layer further comprising an ink portion, the ink portion adhered to at least a portion of the radiation reflecting portion.

15. A system comprising:
a radiation emitting device comprising an interior bottom surface and an internal component portion comprising a top surface and a bottom surface; and
a barrier layer comprising a radiation reflecting portion, the barrier layer adjacent the interior bottom surface and the bottom surface.

16. The system of claim 15, further comprising at least one adhesive portion affixed to at least a portion of the radiation reflecting portion, the at least one adhesive portion removably affixable to at least one of the interior bottom surface and the bottom surface.

17. The system of claim 15, further comprising a lamination portion.

18. The system of claim 15, the thickness of the barrier layer being less than 0.1 millimeters.

19. The system of claim 15, the thickness of the barrier layer being 0.07 millimeters.

20. The system of claim 15, the radiation reflecting portion comprising at least one of copper, lead, silver, tungsten, and gold.
